(19) United States
(12) Patent Application Publication
(10) Pub. No.: US 2025/0246689 A1
(43) Pub. Date: Jul. 31, 2025

(54) COMPRESSION BASKET FOR LEAD ACID BATTERIES

(71) Applicant: FIAMM ENERGY TECHNOLOGY S.P.A., Montecchio Maggiore (VI) (IT)

(72) Inventors: DARIO DAL MASO, Montecchio Maggiore (VI) (IT); DARIO PELOSO, Montecchio Maggiore (VI) (IT); SILVIA CAZZANTI, Montecchio Maggiore (VI) (IT); SILVIO PANTALONI, Montecchio Maggiore (VI) (IT)

(73) Assignee: FIAMM ENERGY TECHNOLOGY S.P.A., Montecchio Maggiore (VI) (IT)

(21) Appl. No.: 18/878,438

(22) PCT Filed: Jun. 28, 2023
(86) PCT No.: PCT/EP2023/025296

§ 371 Date: Dec. 23, 2024

(30) Foreign Application Priority Data
Jul. 1, 2022 (IT) 102022000013972

(51) Int. Cl. H01M 10/16; H01M 50/477; H01M 50/486

(52) U.S. Cl. CPC H01M 10/16; H01M 50/477; H01M 50/486

(57) ABSTRACT

A basket (10) contains and keeps in compression a plate group (100), that is, the set of positive and negative electrodes with interposed the relevant inter-electrode separators; said basket is made of plastic material, chemically resistant to the electrolytic environment of the battery and thermally resistant to the temperatures to which a battery is subjected, to be housed inside the monobloc of 12V lead acid batteries with VRLA AGM technology.

### DESCRIPTION

The present invention relates to a compression basket for lead acid batteries.

More in particular, the present invention relates to a basket for keeping in compression the plate group (electrodes) that supplies 12 V lead acid batteries with VRLA (Valve Regulated Lead Acid batteries) AGM (Absorbed Glass Mat) technology.

More in particular, the present invention relates to a plate group compression basket for lead acid batteries, such as for automotive (automotive) and industrial (telecommunications, data centers, security, energy storage, etc.) applications, which require very strict cyclic and power performance.

As it is known, the accumulators—more commonly known as batteries—with VRLA technology (i.e., sealed with a pressure relief valve that prevents the gases produced during charging to leak out) AGM (i.e., equipped with a special microporous fiberglass separator that absorbs the electrolyte containing it inside the battery) have found wide diffusion in parallel with the development of hybrid-powered vehicles. In hybrid technology, indeed, features such as “stop & start” or braking energy recovery require a high performance of the accumulator, both in respect of repeated starts, and thus resistance to cycling (complete discharge and recharge process), as well as in respect of charge acceptance.

In the context of so-called sustainable mobility and the reduction of harmful emissions, there is an increasing spread of vehicles equipped with hybrid technology, also thanks to government purchase incentives promoted by some Countries. Such vehicles, from the simplest grade relating only to the “stop & start” feature to the more complex “full hybrid,” which allows the use of only the electrically driven powertrain for short distances, require the use of increasingly high-performance accumulators; these have therefore been perfected to be able to guarantee in the first instance a high number of vehicles start cycles in the classic “stop & start” feature.

The evolution has also involved other aspects of batteries such as the ability to ensure their fast and efficient rechargeability in order to be able to recover energy during vehicle braking, and the ability to withstand cycles at deep discharge intensities to ensure the vehicle's on-board services when the engine shuts down at a “stop” such as at traffic lights.

Also in industrial applications, and particularly in the new markets undergoing a strong development (“energy storage,” photovoltaics, etc.), an increasing demand for storage systems with high discharge and recharge capacities and increasingly onerous requirements is occurring.

The growing interest of new markets aimed at energy conservation has led to a significant development of the energy storage sector, further expanding its industrial application.

The accumulators are required to accommodate requirements for high cycling capacity at high depths of discharging, up to 10-30% state of charge (SOC), and efficient recharging, with the ability to recharge efficiently even at very high current rates. The increased deep cycling requirements therefore overlap with the need to still maintain high performance at high discharge current levels.

However, during charge and discharge cycles, particularly with high depths of discharge, the active masses are subject to volume changes due to chemical transformations of the reagents. This event induces a detachment of active material and a change in the inter-electrode distances, which, in the long term, leads to a depletion of the functionality of the accumulator.

In cycles with high depth of discharge, the most common events leading to battery degradation and, consequently, loss of performance, are electrolyte stratification (inhomogeneity of electrolyte density in height and consequent non-uniform utilization of plate surface area) and the inability of the plate or positive electrode to fully recharge, so that it progressively loses capacity in subsequent cycling.

In the lead acid batteries with VRLA AGM technology, it is, therefore, essential to achieve and maintain a high level of plate group compression in order to avoid this type of loss of functionality when subjected to heavy cyclic operating life.

Purpose of the present invention is to provide a compression basket of a plate group supplying 12 V lead acid batteries with VRLA AGM technology to overcome the aforementioned drawbacks.

Document US2014/113177A1 discloses a “lead-acid battery design having versatile form factor” in which the various embodiments of electrochemical cell are intended to improve the stacking of electrode plates. Among the various embodiments, a battery module made to be assembled with other battery modules to achieve, for example, a particular voltage is described. In this particular embodiment, the document discloses the battery module and its insulators, lower and upper, being both provided with inserts and circumscribed laterally by a skirt.

The inserts have the function of increasing the stiffness of the components, helping the module resist deformation or bulging of the container, maintaining lateral compression of the plate group, and containing the increase of active material.

More in particular, the purpose of the present invention is to introduce a compression basket for each plate group, inside the monobloc of a lead acid battery, to strengthen and keep the original degree of compression more constant over time.

Further purpose of the present invention is to improve processability during battery production by facilitating the insertion of the plate group inside the monobloc and significantly reducing the possibility of scraps.

These and other purposes are achieved by the compression basket for lead acid batteries object of the present invention in accordance with the main claim.

The constructional and functional characteristics of the compression basket for lead acid batteries of the present invention may be better understood from the following description, in which reference is made to the attached tables of drawings which represent a preferred and not limiting embodiment and in which:

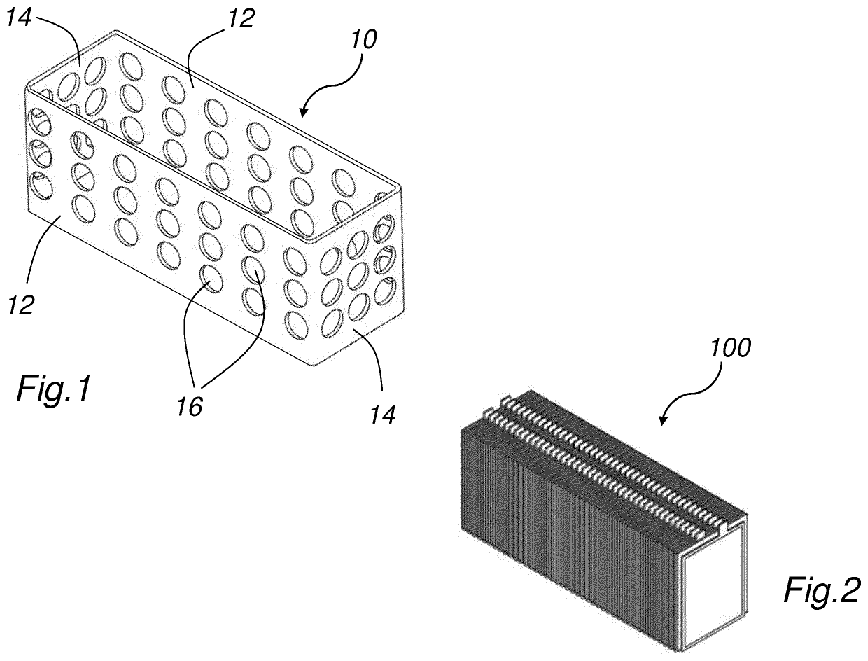

FIG. 1 shows an axonometric view of the compression basket of a plate group for lead acid batteries object of the present invention;

FIG. 2 shows a conventional plate group of a VRLA battery with AGM technology;

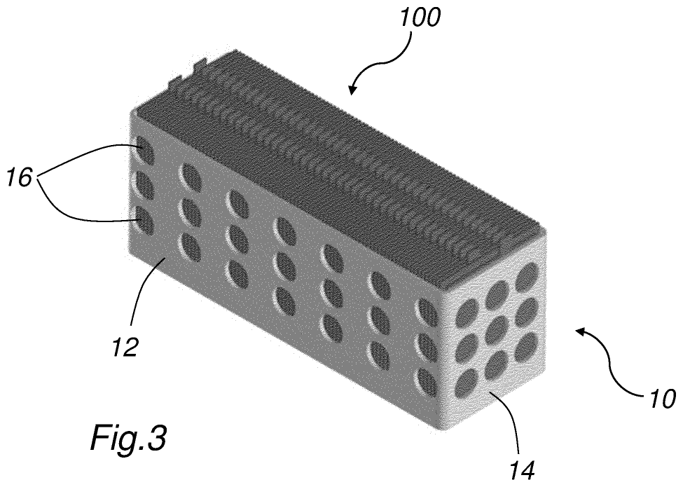

FIG. 3 shows an axonometric view of the basket, object of the present invention, keeping the set of plates of FIG. 2 in compression.

The basket 10 object of the present invention, shown overall in FIGS. 1 to 3, contains and keeps in compression a plate group 100 for supplying 12 V lead acid batteries with VRLA AGM technology, and it is designed to be housed inside a monobloc (not shown) of a battery. Basket 10 is made of plastic material that is chemically resistant to the electrolytic environment of the battery (sulfuric acid solution) and thermally resistant to the temperatures to which a battery is subjected (peaks of 60-80° C.) and is preferably made of polypropylene (PP) or acrylonitrile-butadiene-styrene (ABS) or polyethylene (PE).

The fabrication of basket 10 from other chemical-thermoresistant plastic materials such as, for example, polycarbonate (PC) or polycarbonate/acrylonitrile-butadiene-styrene (PC/ABS) or polyphenylene oxide (PPO) or other similar ones is not excluded.

The parallelepiped-shaped basket 10 consists of a pair of opposing long side panels 12 and a pair of opposing short side panels 14, arranged perpendicularly to each other to form a hollow body, designed to contain and keep in compression a plate group 100; said plate group 100 is conventionally understood as the set of positive and negative electrodes (plates) inside a cell, including the inter-electrode separator placed between each of them as a means of separation and diffusion of the electrolyte.

In a preferred embodiment, basket 10 provides a uniform continuous surface with a plurality of holes 16, uniformly distributed, to dissipate the heat released during the battery charging and discharging reactions.

In another embodiment, when the number of plates is particularly large, the basket (not shown) provides for the mobility of one or both of said short side panels 14 by means of interlocking features with said long side panels 12, in order to ensure adaptability in a wide range of type of batteries, rather than in a single type.

Conventionally, in VRLA batteries, the degree of compression designed for a given plate group is kept constant by the battery container, which is therefore made of higher-performance, thicker external plastics (particularly those of the sides subjected to the pressure of the plate group). However, the container has a tendency to be stressed mechanically by the temperatures to which it is subjected and the forces exerted as a result of changes in the volume of the plate group and the formation of gases in the cells.

The housing of basket 10 in the monobloc of a battery makes it possible to decrease the pressures of plate group 100 on the sides of the container, avoiding the usual mechanical deformations to which the container is generally subjected and, thus, reducing the risk of bulging.

The compression of plate group 100 by basket 10 results in the possibility of using simpler and thinner plastics to make the container, reducing the material cost.

In addition, during battery production, the use of basket 10 facilitates the insertion of plate group 100 inside the container and significantly reduces the possibility of scraps improving processability. In cases where, in order to achieve a high degree of compression (>30 kPa) to ensure high battery cycling performance, the plate groups are particularly thick, indeed, the insertion phase inside the respective cells is particularly delicate; the external electrodes may be damaged (bent or broken), increasing the number of scraps during assembly or the number of potential short-circuits or premature battery life depletion if these are not detected. In these cases, basket 10 allows easier insertion inside the cell while avoiding damage to the outer plates.

In applications requiring horizontal installation of batteries, the housing of basket 10 in the battery monobloc maintains the initial degree of compression of plate group 100 for a longer time and more evenly, obviating the effect of gravity that urges to a temporary and uneven degree of compression, such that the lower plates are more subject to compression than the upper plates.

The basket 10 object of the present invention also keeps in compression the plate group in batteries that have an internal layout in which the plates are placed horizontally, preferably parallel to the battery lid, and, therefore, are not kept in compression by the container sides. In these instances, the use of basket 10 is very effective in providing more uniform compression of the whole plate group 100.

Though the present description refers to an exemplary embodiment and some alternatives, given for illustrative and non-limiting purposes, numerous modifications and variations will appear obvious to a person skilled in the art in the light of the above description. The present invention, therefore, is intended to cover all modifications and variations within the protective scope of the following claims.

1. A basket for containing and keeping under compression a plate group having a set of positive and negative electrodes with interposed interelectrode separators, said basket comprising: a plurality of walls, wherein said basket
is made of plastic material,
is chemically resistant to the electrolytic environment of the battery,
is thermally resistant to the temperatures to which a battery is subjected, and
is configured to be housed inside a monobloc of a 12V lead acid battery with VRLA AGM technology.

2. The basket of claim 1, wherein said battery is made of one of polypropylene (PP), acrylonitrile-butadiene-styrene (ABS), or polyethylene (PE).

3. The basket of claim 1, wherein said battery is made of one of polycarbonate (PC), polycarbonate/acrylonitrile-butadiene-styrene (PC/ABS), or polyphenylene oxide (PPO).

4. The basket of claim 1, wherein said battery includes consists of a pair of opposing long side panels and a pair of opposite short side panels, said pairs being arranged perpendicularly to each other to form a hollow body in the shape of a parallelepiped.

5. The basket of claim 1, wherein said plurality of walls define a uniform continuous surface with a plurality of holes (16), uniformly distributed, and configured to dissipate released during the battery charging and discharging reactions.

6. The basket of claim 4, wherein one or both of said short side panels is movable with respect to said long panels by means of interlocking features connecting said short side panels with said long side panels.
